(19) United States
(12) Patent Application Publication
(10) Pub. No.: US 2020/0372125 A1
(43) Pub. Date: Nov. 26, 2020

(54) METHOD OF PRODUCING A CENTRIFUGAL FAN WHEEL WITHOUT A VOLUTE CASING

(71) Applicant: XIAMEN VORK HEALTH INDUSTRY CO., LTD., Xiamen (CN)

(72) Inventors: Si Zhong, Xiamen (CN); Huang Yang Li, Xiamen (CN)

(21) Appl. No.: 16/516,277

(22) Filed: Jul. 19, 2019

(30) Foreign Application Priority Data
May 21, 2019 (CN) 201910423795.X

(51) Int. Cl. G06F 17/50; F04D 17/08

(52) U.S. Cl. CPC G06F 17/5086; G06F 2217/16; F04D 17/08

(57) ABSTRACT

A method of producing a centrifugal fan wheel without a volute casing includes a design of an outer diameter of a fan wheel and a shape design of a fan blade. The centrifugal fan wheel of the invention reduces the absolute velocity of the fan blade by decreasing an outer diameter of the fan blade to thereby eliminate a self-loss area of jet streams and attain the object of reducing noise. The invention calculates the best air outlet angle and the best air intake angle of the aerodynamic performance through mathematical derivation of aerodynamic equation and theory to thereby achieve the largest output of air volume within the smallest range of full pressure loss.

### BACKGROUND OF THIS INVENTION

### 1. Field of this Invention

This invention relates to an air cleaner and relates particularly to a method of producing a centrifugal fan wheel without a volute casing.

### 2. Description of the Related Art

As shown in FIG. 1, an air duct system of a centrifugal fan wheel without a volute casing is generally applied to the power mechanism of most home air cleaners. The air duct system includes a casing 1′ and a fan wheel 2′. The air duct system of the centrifugal fan wheel is capable of achieving equal air outlet, and providing a straight air intake direction and a straight air outlet direction, and this structure fits requirements of most home air cleaners. Most fan wheels are designed and developed by experience, and that lacks guidance of scientific theory. Nearly, outer diameters of all normal centrifugal fan wheels are designed by single grade outer diameter. Through the simulation analysis of aerodynamics, it can be found that the distribution of the air outlet cross section of jet streams of the fan wheel is not equal for the air duct system of the centrifugal fan wheel without the volute casing. Self-loss jet streams will be caused when air streams are near to an air intake opening, which results in the major source of noise.

### SUMMARY OF THIS INVENTION

The object of this invention is to provide a method of producing a low-noise centrifugal fan wheel without a volute based on scientific theory.

In order to achieve the above object, the invention adopts the following technical solutions:

A method of producing a centrifugal fan wheel without a volute casing comprises a design of an outer diameter of a fan wheel and a shape design of a fan blade.

The design of the outer diameter of the fan wheel comprises the following steps of:

(1) calculating a first grade outer diameter of the fan wheel by an equation R_{fan1}=δ*R_{ad} where δ is a non-dimensional coefficient. δ is more than 0.72 and less than 0.75. R_{ad} is an internal diameter of an air duct. R_{fan1} is the first grade outer diameter of the fan wheel; and

(2) calculating a second grade outer diameter of the fan wheel by an equation R_{fan2}=ξ*R_{fan1}, where R_{fan1} is the first grade outer diameter. ξ is a non-dimensional coefficient. ξ is more than 0.89 and less than 0.92. R_{fan2} is the second grade outer diameter of the fan wheel.

The shape design of the fan blade comprises equations as follows:

P=ω·∫∫ρ(\vec{r}·\vec{ν})νₙdA (2-1)

where P is a power of the fan wheel. ω is an angular velocity of the fan wheel. ρ is an air density. \vec{r} is an outer diameter vector of the fan blade. \vec{ν} is an absolute velocity vector of the fan blade. νₙ is a relative velocity of the fan blade. A is an air outlet area;

an equation (2-2) is derived from the equation (2-1) as follows:

$$\begin{matrix}P = ω \cdot ( \int {\int }_{{A}_{2}} ρ {v}_{2} {r}_{2} cos {α}_{2} {v}_{2 n} dA - \int {\int }_{{A}_{1}} ρ {v}_{1} {r}_{1} cos {α}_{1} {v}_{1 n} dA ) \\ = ω \cdot ( ρ {v}_{2} {r}_{2} cos {α}_{2} {v}_{2 n} {A}_{2} - ρ {v}_{1} {r}_{1} cos {α}_{1} {v}_{1 n} {A}_{1} ) \\ = ω \cdot ρ \cdot {q}_{v} ( {v}_{2} cos {α}_{2} \cdot {r}_{2} - {v}_{1} cos {α}_{1} \cdot {r}_{1} )\end{matrix} \qquad ( 2 \text{-} 2 )$$

where ν₂ is an absolute velocity of an outer diameter of the fan blade. ν₁ is an absolute velocity of an internal diameter of the fan blade. r₂ is the outer diameter of the fan blade. r₁ is the internal diameter of the fan blade. ν₂ₙ is a relative velocity of the outer diameter of the fan blade. ν₁ₙ is a relative velocity of the internal diameter of the fan blade. A₂ is an air outlet area of the outer diameter of the fan blade. A₁ is an air outlet area of the internal diameter of the fan blade. α₂ is an air outlet angle of the fan blade. α₁ is an air intake angle of the fan blade. qᵥ is an air volume generated by the fan blade;

an equation (2-3) is derived from dividing the equation (2-2) as follows:

$$\{ \begin{matrix}P = {ω}^{2} \cdot ρ \cdot {q}_{v} ( {cos}^{2} {α}_{2} \cdot {r}_{2} - {cos}^{2} {α}_{1} \cdot {r}_{1} ) \\ {q}_{v} = {v}_{2 n} \cdot A = ω \cdot {r}_{2} \cdot sin {α}_{2} \cdot cos {α}_{2} \\ {q}_{v} = {v}_{1 n} \cdot A = ω \cdot {r}_{1} \cdot sin {α}_{1} \cdot cos {α}_{1}\end{matrix} \qquad ( 2 \text{-} 3 )$$

equations (2-4) and (2-5) are derived from transforming the equation (2-2),

sin α₂·cos α₂(1−cos² α₂) (2-4)

sin α₁·cos α₁(1+cos² α₁) (2-5)

Preferably, the air outlet angle α₂ is between 58° and 64° and the air intake angle α₁ is between 37° and 45°.

Preferably, the air outlet angle α₂ is 60°, and the air intake angle α₁ is 38°.

After adopting the above method, the invention comprises the design of the outer diameter of the fan wheel and the shape design of the fan blade. The invention combines aerodynamic simulation and theoretical calculation of rotating machine to propose the method of designing the centrifugal fan wheel without the volute casing. It determines the core calculation parameters, and removes the source of noise by eliminating self-loss jet streams to thereby achieve the object of increasing the aerodynamic performance.

The centrifugal fan wheel of the invention reduces the absolute velocity of the fan blade [symbol] =ω·R_{fan}·cos α₂ by decreasing the outer diameter of the fan blade in a concentration area of the jet streams to thereby eliminate a self-loss area of the jet streams, and attain the object of reducing noise. The invention determines the self-loss area of the jet streams of an air duct system of the centrifugal fan wheel without the volute casing by the aerodynamic simulation, and provides the fan wheel which has the outer diameter designed by the second grade outer diameter. The invention introduces the second grade outer diameter of the coefficient ξ to thereby eliminate the self-loss of the jet streams which is near to an air intake opening, and reduce noise without decreasing the air volume.

The invention is further described with drawings and detailed description as follows.

### BRIEF DESCRIPTION OF THE DRAWINGS

FIG. 1 is a schematic view showing a structure of the air duct system of the centrifugal fan wheel without the volute casing;

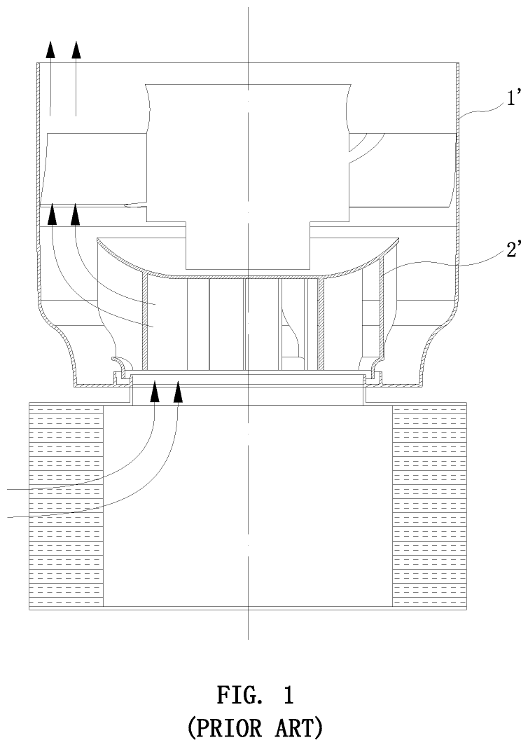

FIG. 2 is an axonometric view of the fan wheel of this invention;

FIG. 3 is a top plan view of the fan wheel of this invention; and

FIG. 4 is a schematic view showing parameters of the fan wheel of this invention.

### DETAILED DESCRIPTION OF THE PREFERRED EMBODIMENTS

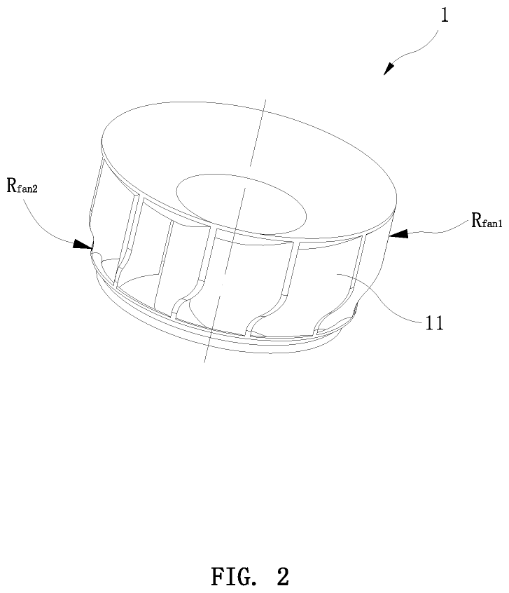

As shown in FIGS. 2 to 4, the invention is a method of producing a centrifugal fan wheel without a volute casing includes a design of an outer diameter of the fan wheel 1 and a shape design of a fan blade 11.

The design of the outer diameter of the fan wheel 1 comprises the following steps of:

(1) calculating a first grade outer diameter of the fan wheel 1 by an equation R_{fan1}=δ*R_{ad} where δ is a non-dimensional coefficient. δ is more than 0.72 and less than 0.75. R_{ad} is an internal diameter of an air duct. R_{fan1} is the first grade outer diameter of the fan wheel; and

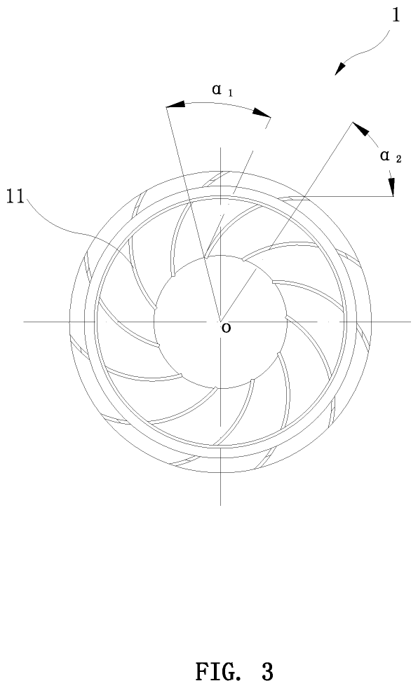

(2) calculating a second grade outer diameter of the fan wheel 1 by an equation R_{fan2}=ξ*R_{fan1}, where R_{fan1} is the first grade outer diameter. ξ is a non-dimensional coefficient. ξ is more than 0.89 and less than 0.92. R_{fan2} is the second grade outer diameter of the fan wheel, as shown in FIG. 3.

The shape design of the fan blade 11 comprises equations as follows:

P=ω·∫∫ρ(\vec{r}·\vec{ν})\vec{ν}ₙdA (2-1)

where P is a power of the fan wheel. ω is an angular velocity of the fan wheel. ρ is an air density. \vec{r} is an outer diameter vector of the fan blade. \vec{ν} is an absolute velocity vector of the fan blade. νₙ is a relative velocity of the fan blade. A is an air outlet area;

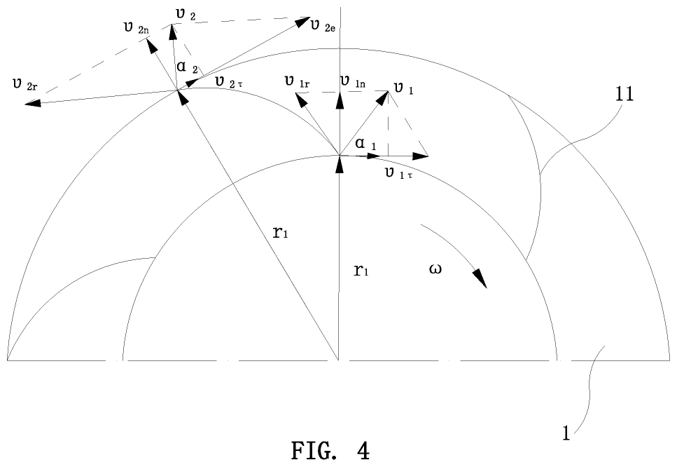

an equation (2-2) is derived from the equation (2-1) as follows:

$$\begin{matrix}P = ω \cdot ( \int {\int }_{{A}_{2}} ρ {v}_{2} {r}_{2} cos {α}_{2} {v}_{2 n} dA - \int {\int }_{{A}_{1}} ρ {v}_{1} {r}_{1} cos {α}_{1} {v}_{1 n} dA ) \\ = ω \cdot ( ρ {v}_{2} {r}_{2} cos {α}_{2} {v}_{2 n} {A}_{2} - ρ {v}_{1} {r}_{1} cos {α}_{1} {v}_{1 n} {A}_{1} ) \\ = ω \cdot ρ \cdot {q}_{v} ( {v}_{2} cos {α}_{2} \cdot {r}_{2} - {v}_{1} cos {α}_{1} \cdot {r}_{1} )\end{matrix} \qquad ( 2 \text{-} 2 )$$

where ν₂ is an absolute velocity of an outer diameter of the fan blade. ν₁ is an absolute velocity of an internal diameter of the fan blade. r₂ is the outer diameter of the fan blade. r₁ is the internal diameter of the fan blade. ν₂ₙ is a relative velocity of the outer diameter of the fan blade. ν₁ₙ is a relative velocity of the internal diameter of the fan blade. A₂ is an air outlet area of the outer diameter of the fan blade. A₁ is an air outlet area of the internal diameter of the fan blade. α₂ is an air outlet angle of the fan blade. α₁ is an air intake angle of the fan blade. qᵥ is an air volume generated by the fan blade; as shown in FIG. 4.

an equation (2-3) is derived from dividing the equation (2-2) as follows:

$$\{ \begin{matrix}P = {ω}^{2} \cdot ρ \cdot {q}_{v} ( {cos}^{2} {α}_{2} \cdot {r}_{2} - {cos}^{2} {α}_{1} \cdot {r}_{1} ) \\ {q}_{v} = {v}_{2 n} \cdot A = ω \cdot {r}_{2} \cdot sin {α}_{2} \cdot cos {α}_{2} \\ {q}_{v} = {v}_{1 n} \cdot A = ω \cdot {r}_{1} \cdot sin {α}_{1} \cdot cos {α}_{1}\end{matrix} \qquad ( 2 \text{-} 3 )$$

In order to maximize the aerodynamic performance, the air outlet angle α₂ and the air intake angle α₁ must be adjusted so that the air volume qᵥ generated by the fan wheel is the largest, the full pressure is the smallest, and the loss is the lowest when the power P is the smallest.

equations (2-4) and (2-5) are derived from transforming the equation (2-2) in order to optimize the air intake angle and the air outlet angle.

sin α₂·cos α₂(1−cos² α₂) (2-4)

sin α₁·cos α₁(1+cos² α₁) (2-5)

When the solutions of the equations (2-4) and (2-5) take the maximum value, the angles α₂ and α₁ which are obtained are the best values. The obtained air outlet angle α₂ is 60°, and the obtained air intake angle α₁ is 38°. The invention specifies the protected range of the air outlet angle α₂ is between 58° and 64°, and the protected range of the air intake angle α₁ is between 37° and 45°.

The best air outlet angle α₂ is 60°. The best air intake angle α₁ is 38°.

While the embodiment of the invention is shown and described above, it is understood that the embodiment is not intended to limit the technical scope of the invention. Moreover, it is understood that further detailed revisions, equivalent variations, and modifications may be made without departing from the scope of the invention.

What is claimed is:

1. A method of producing a centrifugal fan wheel without a volute casing, comprising a design of an outer diameter of a fan wheel and a shape design of a fan blade, wherein a second grade outer diameter is applied to design said outer diameter of said fan wheel,
said design of said outer diameter of said fan wheel comprising the following steps of:
(1) calculating a first grade outer diameter of said fan wheel by an equation R_{fan1}=δ*R_{ad} where δ is a non-dimensional coefficient, δ being more than 0.72 and less than 0.75, R_{ad} being an internal diameter of an air duct, R_{fan1} being said first grade outer diameter of said fan wheel; and
(2) calculating said second grade outer diameter of said fan wheel by an equation R_{fan2}=ξ*R_{fan1}, where R_{fan1} is said first grade outer diameter, ξ being a non-dimensional coefficient, ξ being more than 0.89 and less than 0.92, R_{fan2} being said second grade outer diameter of said fan wheel.

2. The method according to claim 1, wherein said shape design of said fan blade comprises equations as follows:
P=ω·∫∫ρ(\vec{r}·\vec{ν})νₙdA (2-1)
where P is a power of said fan wheel, ω being an angular velocity of said fan wheel, ρ being an air density, \vec{r} being an outer diameter vector of said fan blade, \vec{ν} being an absolute velocity vector of said fan blade, νₙ being a relative velocity of said fan blade, A being an air outlet area;
an equation (2-2) being derived from said equation (2-1) as follows:
$$\begin{matrix}P = ω \cdot ( \int {\int }_{{A}_{2}} ρ {v}_{2} {r}_{2} cos {α}_{2} {v}_{2 n} dA - \int {\int }_{{A}_{1}} ρ {v}_{1} {r}_{1} cos {α}_{1} {v}_{1 n} dA ) \\ = ω \cdot ( ρ {v}_{2} {r}_{2} cos {α}_{2} {v}_{2 n} {A}_{2} - ρ {v}_{1} {r}_{1} cos {α}_{1} {v}_{1 n} {A}_{1} ) \\ = ω \cdot ρ \cdot {q}_{v} ( {v}_{2} cos {α}_{2} \cdot {r}_{2} - {v}_{1} cos {α}_{1} \cdot {r}_{1} )\end{matrix} \qquad ( 2 \text{-} 2 )$$
where ν₂ is an absolute velocity of an outer diameter of said fan blade, ν₁ being an absolute velocity of an internal diameter of said fan blade, r₂ being said outer diameter of said fan blade, r₁ being said internal diameter of said fan blade, ν₂ₙ being a relative velocity of said outer diameter of said fan blade, ν₁ₙ being a relative velocity of said internal diameter of said fan blade, A₂ being an air outlet area of said outer diameter of said fan blade, A₁ being an air outlet area of said internal diameter of said fan blade, α₂ being an air outlet angle of said fan blade, α₁ being an air intake angle of said fan blade, qᵥ being an air volume generated by said fan blade;
an equation (2-3) being derived from dividing said equation (2-2) as follows:
$$\{ \begin{matrix}P = {ω}^{2} \cdot ρ \cdot {q}_{v} ( {cos}^{2} {α}_{2} \cdot {r}_{2} - {cos}^{2} {α}_{1} \cdot {r}_{1} ) \\ {q}_{v} = {v}_{2 n} \cdot A = ω \cdot {r}_{2} \cdot sin {α}_{2} \cdot cos {α}_{2} \\ {q}_{v} = {v}_{1 n} \cdot A = ω \cdot {r}_{1} \cdot sin {α}_{1} \cdot cos {α}_{1}\end{matrix} \qquad ( 2 \text{-} 3 )$$
equations (2-4) and (2-5) being derived from transforming said equation (2-2),
sin α₂·cos α₂(1−cos² α₂) (2-4)
sin α₁·cos α₁(1+cos² α₁) (2-5)

3. The method according to claim 1, wherein said air outlet angle α₂ is between 58° and 64°, said air intake angle α₁ being between 37° and 45°.

4. The method according to claim 1, wherein said air outlet angle α₂ is 60°, said air intake angle α₁ being 38°.
